(19) United States
(12) Patent Application Publication
(10) Pub. No.: US 2026/0359457 A1
(43) Pub. Date: Nov. 12, 2026

(54) PRIVILEGED FILE SYSTEM OPERATIONS DETECTOR FOR WINDOWS NT SYSTEMS

(71) Applicant: Palo Alto Networks, Inc., Santa Clara, CA (US)

(72) Inventors: Asher Davila Loranca, San Jose, CA (US); Ruian Duan, Fremont, CA (US); Malav Vyas, Milpitas, CA (US)

(21) Appl. No.: 19/202,957

(22) Filed: May 8, 2025

(51) Int. Cl. G06F 21/60; G06F 21/62

(52) U.S. Cl. CPC G06F 21/604; G06F 21/6281

(57) ABSTRACT

Global application programming interface (API) hooking is performed for a plurality of processes running on an endpoint device. An integrity level associated with a first process of the plurality of processes is determined. In response to determining that the integrity level associated with the first process has elevated privileges, it is determined whether any security identifiers included in a set of security identifiers is included in an access control list associated with a file on which the first process is going to operate. A corresponding name of the first process and a corresponding name of the file is logged in a logfile based on whether one or more security identifiers included in the set of security identifiers is included in the access control list associated with the file on which the first process is going to operate.

### BACKGROUND OF THE INVENTION

The security landscape of file systems has been increasingly challenged by vulnerabilities related to privileged file systems operations in Windows Systems. These vulnerabilities introduce significant risks by potentially allowing unauthorized access and manipulation of files and directories. Such vulnerabilities can lead to issues, such as privilege escalation, data leakage, system compromise, and denial of service, all of which can disrupt normal operations.

### BRIEF DESCRIPTION OF THE DRAWINGS

Various embodiments of the invention are disclosed in the following detailed description and the accompanying drawings.

FIG. 1 is an example of a privileged file system operation vulnerability in accordance with some embodiments.

FIG. 2 is a block diagram illustrating a system to detect privileged file system operation vulnerabilities in accordance with some embodiments.

FIG. 3 is an example set of security identifiers in accordance with some embodiments.

FIG. 4 is a flow diagram illustrating a process to detect privileged file system operation vulnerabilities in accordance with some embodiments.

FIG. 5 is an example report in accordance with some embodiments.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

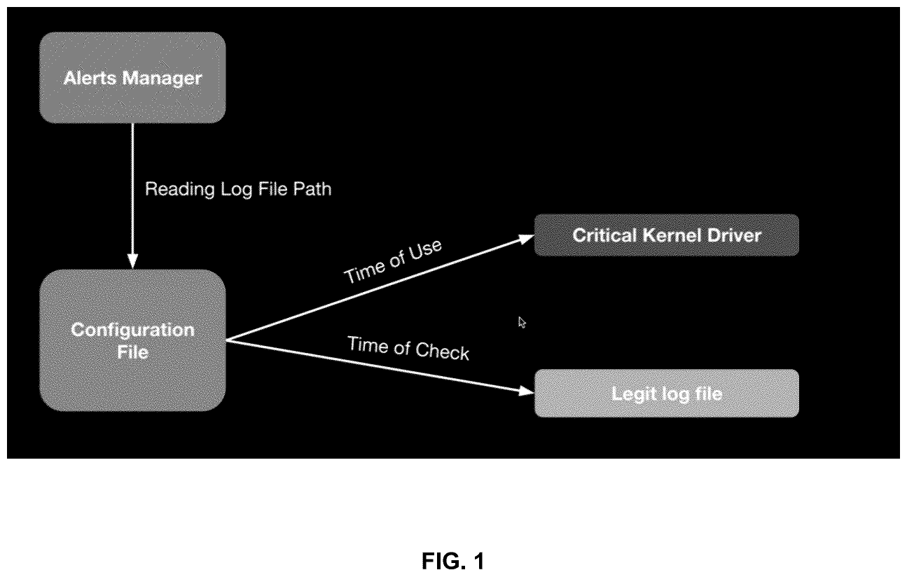

Systems and methods to detect privileged file system operation vulnerabilities are disclosed herein. The most common technique for exploiting file system operations is a symlink redirection, where an adversary places a symbolic link so that a user or application unknowingly accesses the link's endpoint, believing it to be the intended file. As seen in FIG. 1, an alerts manager is reading a log file path associated with a configuration file. At the time of check, the configuration file points to a legit log file. However, in between the time of check and the time of use, the configuration file has been modified to point to a critical kernel driver. When reading the log file path associated with the configuration file, the alerts manager may overwrite or delete the content associated with the critical kernel driver, which will inadvertently cause the system to crash, freeze, or become completely unbootable.

In some embodiments, the endpoint file is an output. The modification occurs on the endpoint itself rather than on the intended file location. These changes can include appending, overwriting, corrupting, altering permissions, or other modifications. In some variants, the adversary has control over the specific modification, while in others, they do not. The former is particularly dangerous, as it can enable privilege escalation or the injection of false data. However, even uncontrolled modifications can be harmful, potentially exposing sensitive information or damaging critical system or application files.

In some embodiments, the endpoint file is an input. This enables an adversary to supply malformed data or manipulate the information the application processes. This can potentially allow the attacker to influence the application's behavior.

Another common exploitation technique is known as untrusted search path, where the application relies on an externally provided path to locate critical resources. If this path points to locations outside the product's control, an attacker may execute unauthorized programs, access restricted data, or alter configuration files unexpectedly. When an application uses such a search path to locate essential components like executables, an attacker could redirect it to a malicious file, which the application might then execute.

The systems and methods disclosed herein detect and notify developers of such privileged file system operation vulnerabilities, such as create, move, overwrite, and delete. This enables developers to patch vulnerabilities before attackers exploit them and prevents unauthorized access or modifications of files.

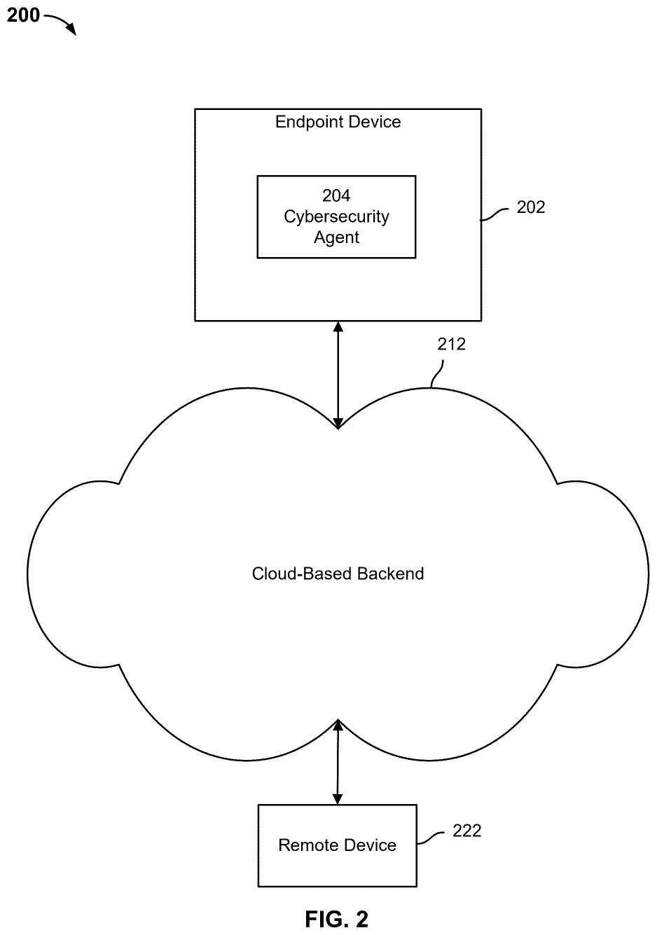

FIG. 2 is a block diagram illustrating a system to detect privileged file system operation vulnerabilities in accordance with some embodiments. In the example shown, system 200 includes an endpoint device 202 in communication with a cloud-based backend 212. Endpoint device 202 may be a laptop, a desktop, a server, a mobile device, etc. In some embodiments, endpoint device 202 is a Windows endpoint device capable of running the Windows operating system.

Endpoint device 202 includes a cybersecurity agent 204 (e.g., Cortex XDR agent). Cybersecurity agent 204 is configured to determine whether endpoint device 202 is subject to one or more privileged file system operation vulnerabilities.

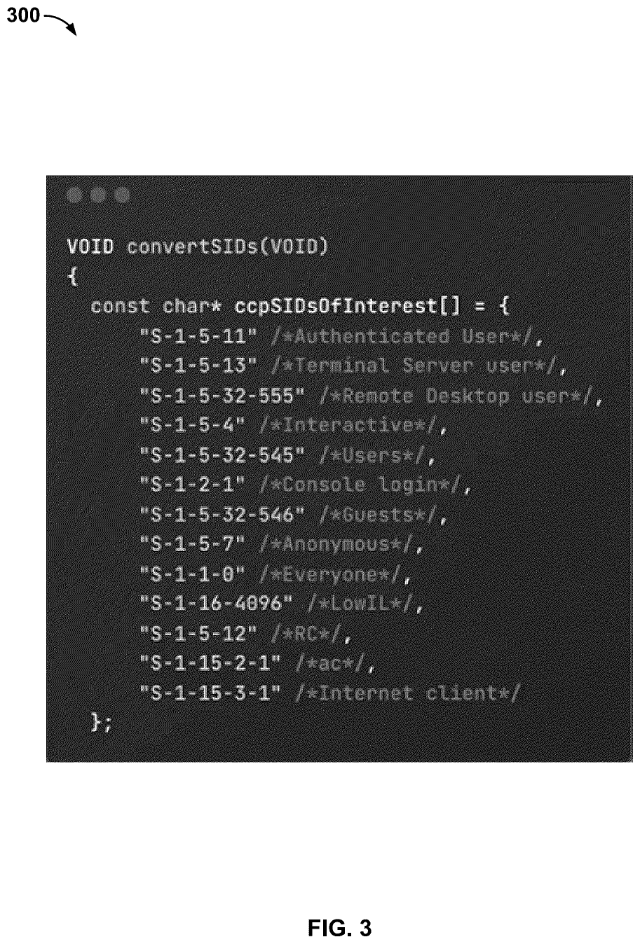

Cybersecurity agent 204 is configured to determine whether endpoint device 202 is subject to one or more privileged file system operation vulnerabilities by defining a set of SIDs. The set of SIDs includes one or more low-privilege users. FIG. 3 is an example set of security identifiers in accordance with some embodiments. The set of security identifiers 300 is not an exhaustive list, rather it is meant to demonstrate how the set of security identifiers may be defined. Security identifiers (SIDs) included in the set 300 are low-privilege users. A low-privilege user has limited permissions when compared to an administrator user. Users are assigned low privileges to reduce the risk of accidental or malicious changes to the system.

Cybersecurity agent 204 is configured to utilize dynamic binary instrumentation to hook into every process running with elevated privileges (e.g., a process with an integrity level >MEDIUM). Dynamic binary instrumentation is a technique used in software analysis that allows developers to insert custom code into a program while it's running, without modifying the source code or recompiling it. In some embodiments, cybersecurity agent 204 is configured to perform global application programming interface (API) hooking.

Other systems focus on static analysis, identifying vulnerabilities by examining the source code or analyzing a decompiled version of the binary to detect potential issues without executing the program. Static analysis may generate false positives (i.e., report issues that aren't actually problems) and false negatives (i.e., miss real bugs entirely). This is because static analysis has limited context, since it analyzes the code without running it, so it doesn't see real inputs, execution paths, or system states.

For processes running with elevated privileges, the cybersecurity agent 304 is configured to intercept the syscalls (system calls) related to file system operations, such as NTCreateFile, NTOpen, etc. Cybersecurity agent 204 is configured to verify an access control list of the file or folder being operated on by the intercepted syscalls related to file system operations. Cybersecurity agent 204 is configured to monitor the operations of exiting files and folders. Cybersecurity agent 204 is configured to monitor the probe/access attempt to non-existing files and folders on endpoint device 302.

Based on the access control list, cybersecurity agent 204 is configured to determine whether any of the files or folders associated with the processes running with elevated privileges can be operated on by a user included in the set of SIDs. In response to determining a file or folder associated with the processes running with elevated privileges can be operated on by a user included in the set of SIDs, cybersecurity agent 204 is configured to register this event into a log file.

At the end of analyzing the processes running with elevated privileges, cybersecurity agent 204 is configured to generate a report based on the information stored in the log file. The analysis includes all of the vulnerable file system operations performed by the concerned software and its corresponding exploitability risk. Cybersecurity agent 204 is configured to provide cloud-based backend 212 the report that includes the analysis. In some embodiments, cybersecurity agent 204 provides the log file to cloud-based backend 212 and cloud-based backend generates the report.

Cloud-based backend 212 may be provided by a cloud provider, such as Amazon Web Services®, Google Cloud Platform®, Microsoft Azure®, etc. The information included in the report is stored in a database or object storage provided by cloud-based backend 212. The information stored by cloud-based backend 212 is accessible by remote device 222. Remote device 222 may be a computer, a laptop, a desktop, a server, a tablet, a mobile device, a smart device, etc. A software developer associated with remote device 222 may utilize the report to debug and patch an application installed on endpoint device 202. In some embodiments, the application is in a continuous integration testing phase. In some embodiments, the application is in a continuous delivery phase after production is completed.

The applications may be associated with user-mode programs, drivers (user-mode and kernel-mode), bootloader, kernel-mode programs, system services, background processes, and/or Windows Subsystem.

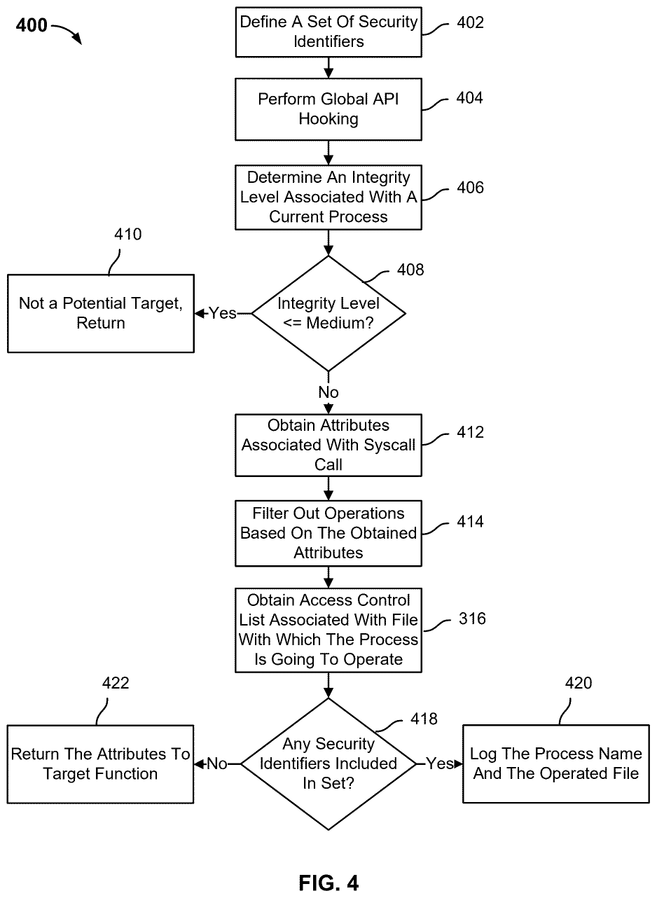

FIG. 4 is a flow diagram illustrating a process to detect privileged file system operation vulnerabilities in accordance with some embodiments. Process 400 may be performed by a cybersecurity agent, such as cybersecurity agent 204.

At 402, a set of security identifiers is defined. The set of SIDs includes one or more low-privilege users. A low-privilege user has limited permissions when compared to an administrator user.

At 404, global API hooking is formed across multiple processes system-wide. Global API hooking enables the cybersecurity agent to intercept API calls system wide. The cybersecurity agent may monitor, modify, or block function calls to Windows API functions. A dynamic link library or code is injected into multiple target processes.

At 406, an integrity level associated with a current process is determined. The integrity level associated with the current process (integrity level ranking from low->high) may be “UNTRUSTED,” “LOW,” “MEDIUM,” “HIGH,” “SYSTEM,” “PROTECTED” or “SECURE PROCESS.” An integrity level associated with a process is assigned by the operating system.

At 408, it is determined whether the integrity level associated with the current process is less than or equal to medium. In response to determining that the integrity level associated with the current process is less than or equal to medium, process 400 proceeds to 410 where the cybersecurity agent determines that the current process is not a potential target. The cybersecurity may return back to step 406 to determine the integrity level associated with a subsequent process, if there are more processes to analyze. Otherwise, process 400 ends.

In response to determining that the integrity level associated with the current process is not less than or equal to medium, process 400 proceeds to 412.

At 412, attributes associated with the syscall associated with the current process are obtained. This may include metadata or contextual information about the syscall either before, during, or after the syscall associated with the current process is executed. Examples attributes include the syscall name, arguments, calling process, calling thread, return value, timing info, origin, and/or CPU state.

At 414, the current process is filtered based on the obtained syscall attributes associated with the current process. For example, the cybersecurity agent may only be concerned with file overwrites. The cybersecurity agent may determine the one or more syscalls associated with the current process to determine whether the current process will perform a file overwrite. Processes that don't perform particular pre-defined actions may be ignored based on their syscalls.

The cybersecurity agent may return back to step 406 to determine the integrity level associated with a subsequent process, if there are more processes to analyze. Otherwise, process 400 ends. In some embodiments, step 414 is optional.

At 416, an access control list associated with a file on which the process is going to operate is obtained.

At 418, it is determined whether any of the security identifiers included in the set of security identifiers is included in the access control list. In response to determining there is at least one security identifier from the set of security identifiers included in the access control list associated with the file, process 400 proceeds to 420.

In response to determining there is not at least one security identifier from the set of security identifiers included in the access control list associated with the file, process 400 proceeds to 422.

At 420, the process name and the file on which the process operated is logged. The cybersecurity agent may return back to step 406 to determine the integrity level associated with a subsequent process, if there are more processes to analyze. Otherwise, process 400 ends.

At 422, the attributes associated with the syscall are provided to the real syscall that was intercepted at 404.

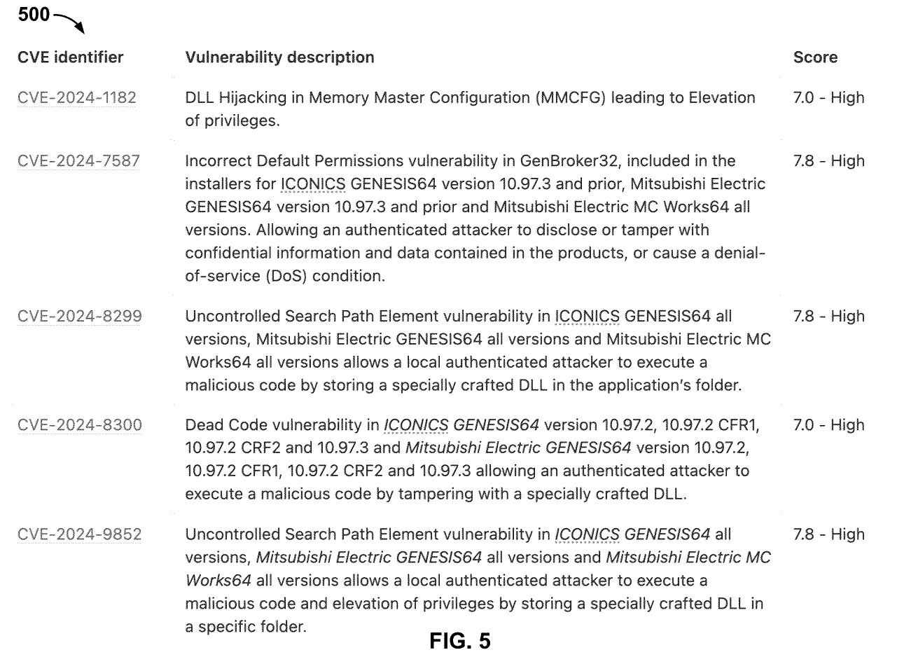

FIG. 5 is an example report in accordance with some embodiments. In the example shown, report 500 lists the vulnerabilities present in an application that was detected by cybersecurity agent 204 utilizing the techniques disclosed herein.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A method, comprising:
performing global application programming interface (API) hooking for a plurality of processes running on an endpoint device;
determining an integrity level associated with a first process of the plurality of processes;
in response to determining that the integrity level associated with the first process has an elevated privilege, determining whether any security identifiers included in a set of security identifiers is included in an access control list associated with a file on which the first process is going to operate; and
logging in a logfile a corresponding name of the first process and a corresponding name of the file based on whether one or more security identifiers included in the set of security identifiers is included in the access control list associated with the file on which the first process is going to operate.

2. The method of claim 1, further comprising defining the set of security identifiers.

3. The method of claim 2, wherein the one or more security identifiers included in the set of security identifiers are low privilege users.

4. The method of claim 1, wherein performing global API hooking includes intercepting API calls associated with the plurality of processes running on the endpoint device.

5. The method of claim 1, wherein the integrity level associated with the first process is not less than or equal to a medium integrity level.

6. The method of claim 1, further comprising obtaining attributes of one or more syscalls associated with the first process.

7. The method of claim 6, wherein the attributes of the one or more syscalls associated with the first process include metadata or contextual information about the one or more syscalls before, during, or after the one or more syscalls associated with the current process are executed.

8. The method of claim 7, further comprising filtering out the first process based on the obtained attributes of the one or more syscalls associated with the first process.

9. The method of claim 7, further comprising obtaining the access control list associated with the file on which the first process is going to operate.

10. The method of claim 6, further comprising returning the attributes of the one or more syscalls associated with the first process to a target function associated with the first process in response to determining that none of security identifiers included in the set of security identifiers is included in the access control list associated with the file on which the first process is going to operate.

11. The method of claim 1, wherein a report is generated based on information included in the logfile.

12. The method of claim 11, wherein the information included in the logfile includes at least a process name associated with the first process and a filename associated with the file.

13. A system, comprising:
a processor configured to:
perform global application programming interface (API) hooking for a plurality of processes running on an endpoint device;
determine an integrity level associated with a first process of the plurality of processes;
in response to determining that the integrity level associated with the first process has elevated privileges, determine whether any security identifiers included in a set of security identifiers is included in an access control list associated with a file on which the first process is going to operate; and
logging in a logfile a corresponding name of the first process and a corresponding name of the file based on whether one or more security identifiers included in the set of security identifiers is included in the access control list associated with the file on which the first process is going to operate; and
a memory coupled to the processor and configured to provide the processor with instructions.

14. The system of claim 13, wherein the processor is further configured to define the set of security identifiers.

15. The system of claim 14, wherein the one or more security identifiers included in the set of security identifiers are low privilege users.

16. The system of claim 13, wherein to perform global API hooking, the processor is configured to intercept API calls associated with the plurality of processes running on the endpoint device.

17. The system of claim 16, wherein the integrity level associated with the first process is not less than or equal to a medium integrity level.

18. The system of claim 13, wherein the processor is further configured to obtain attributes of one or more syscalls associated with the first process.

19. The system of claim 18, wherein the attributes of the one or more syscalls associated with the first process include metadata or contextual information about the one or more syscalls before, during, or after the one or more syscalls associated with the current process are executed.

20. A computer program product embodied in a non-transitory computer readable medium and comprising computer instructions for:
performing global application programming interface (API) hooking for a plurality of processes running on an endpoint device;
determining an integrity level associated with a first process of the plurality of processes;
in response to determining that the integrity level associated with the first process has elevated privileges, determining whether any security identifiers included in a set of security identifiers is included in an access control list associated with a file on which the first process is going to operate; and
logging in a logfile a corresponding name of the first process and a corresponding name of the file based on whether one or more security identifiers included in the set of security identifiers is included in the access control list associated with the file on which the first process is going to operate.
